(19) United States
(12) Patent Application Publication
(10) Pub. No.: US 2016/0086149 A1
(43) Pub. Date: Mar. 24, 2016

(54) MERCHANDISE ITEM REGISTRATION APPARATUS

(71) Applicant: CASIO COMPUTER CO., LTD., Tokyo (JP)

(72) Inventor: Yoshiaki YUYAMA, Tokyo (JP)

(73) Assignee: CASIO COMPUTER CO., LTD., Tokyo (JP)

(21) Appl. No.: 14/859,722

(22) Filed: Sep. 21, 2015

(30) Foreign Application Priority Data
Sep. 22, 2014 (JP) 2014-192512

(51) Int. Cl. G06Q 20/20

(52) U.S. Cl. CPC G06Q 20/208

(57) ABSTRACT

A merchandise item registration apparatus includes: an item code acquiring unit configured to read a merchandise item code associated with an object to be identified; an image information acquiring unit configured to acquire image information about the object to be identified by imaging the object to be identified at a time of sales registration; and an identifying unit configured to identify a merchandise type of the object to be identified based on the read merchandise item code when the merchandise item code is successfully read by the item code acquiring unit, and associate the image information acquired by the image information acquiring unit with the identified merchandise type, the image information being accumulated as a piece of a plurality of pieces of reference image information to be referred to at a time of merchandise type identification based on object recognition.

### CROSS-REFERENCE TO RELATED APPLICATIONS

This application is based upon and claims the benefit of priority from prior Japanese Patent Application No. 2014-192512, filed Sep. 22, 2014, the entire contents of which are incorporated herein by reference.

### BACKGROUND OF THE INVENTION

1. Field of the Invention

The present invention relates to merchandise item registration apparatuses.

2. Description of the Related Art

In recent years, merchandise item registration apparatuses that identify merchandise items by extracting feature amounts from image data obtained by imaging the merchandise items, and register sales of the identified merchandise items (count the identified merchandise items as sold merchandise items) have been becoming common. As this type of merchandise item registration apparatus is used for checkout with a cash register, sales of vegetables and fruits without bar codes can be readily registered, and the load on each operator can be reduced.

For example, JP 2013-89258 A discloses an information processing apparatus that compares image information about an object imaged by an imaging unit with reference image information, and causes a display unit to display the merchandise items corresponding to the reference image information having degrees of similarity within a predetermined range, as candidate merchandise items for the object.

By the technology disclosed in JP 2013-89258 A, the reference image information to be used in identifying merchandise items is fixed, and an operator selects from among candidates, unless reference image information having an extremely high degree of similarity to the image information about the imaged merchandise item is registered.

Therefore, every time a merchandise item (a green apple, for example) that is classified under the same merchandise category but does not have a very high degree of similarity to the reference image information (“red apple”, for example) is checked out, the operator needs to perform the above described selection. As described above, with the technology disclosed in JP 2013-89258 A, there is the need to repeat a complicated operation similar to the operation performed at the time of sales registration of a merchandise item.

### SUMMARY OF THE INVENTION

Therefore, the present invention aims to provide a merchandise item registration apparatus that can reduce the complexity of registering sales of merchandise items.

A merchandise item registration apparatus includes: an item code acquiring unit configured to read a merchandise item code associated with an object to be identified; an image information acquiring unit configured to acquire image information about the object to be identified by imaging the object to be identified at a time of sales registration; and an identifying unit configured to identify a merchandise type of the object to be identified based on the read merchandise item code when the merchandise item code is successfully read by the item code acquiring unit, and associate the image information acquired by the image information acquiring unit with the identified merchandise type, the image information being accumulated as a piece of a plurality of pieces of reference image information to be referred to at a time of merchandise type identification based on object recognition.

According to the present invention, the complexity of registering sales of merchandise items can be reduced.

Advantages of the invention will be set forth in the description which follows, and in part will be obvious from the description, or may be learned by practice of the invention. The Advantages of the invention may be realized and obtained by means of the instrumentalities and combinations particularly pointed out hereinafter.

The accompanying drawings, which are incorporated in and constitute a part of the specification, illustrate embodiments of the invention, and together with the general description given above and the detailed description of the embodiments given below, serve to explain the principles of the invention.

### BRIEF DESCRIPTION OF THE SEVERAL VIEWS OF THE DRAWING

FIG. 1 is an external perspective view of a checkout system as a merchandise item registration apparatus according to a first embodiment of the present invention;

FIG. 2 is a diagram showing the structures of a merchandise item identification device and a POS terminal;

FIG. 3 is a functional block diagram including the microcomputer of the merchandise item identification device;

FIG. 4 is a flowchart showing a merchandise item registration process based on object recognition to be performed by the merchandise item registration apparatus;

FIG. 5A shows an example of screen display during a process being performed by the merchandise item registration apparatus, and an example of a confirmation screen on display;

FIG. 5B shows an example of screen display during a process being performed by the merchandise item registration apparatus, and an example of a select screen on display;

FIG. 6 is a diagram for explaining additional registration to be performed by the merchandise item registration apparatus;

FIG. 7 is a flowchart showing a merchandise item registration process based on object recognition to be performed by a merchandise item registration apparatus according to a second embodiment of the present invention;

FIG. 8 is an example of a display screen in an additional registration mode;

FIG. 9 is a diagram for explaining additional registration to be performed by the merchandise item registration apparatus; and

FIG. 10 is a flowchart showing a merchandise item registration process to be performed by a merchandise item registration apparatus according to a third embodiment of the present invention.

### DETAILED DESCRIPTION OF THE INVENTION

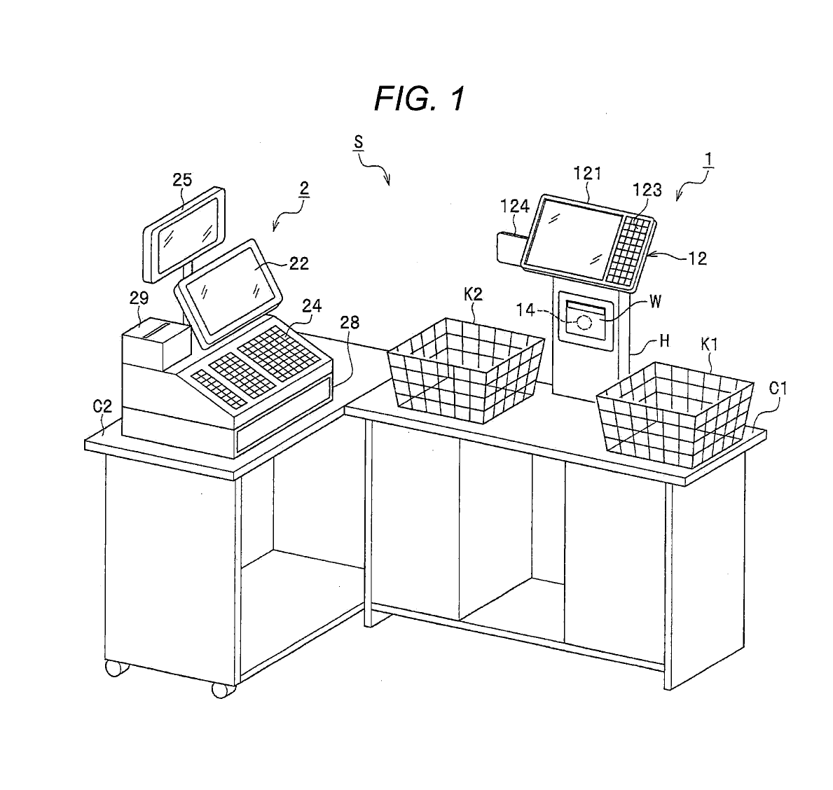

The following is a detailed description of embodiments of the present invention, with reference to the accompanying drawings. In the description below, each merchandise item to be imaged by a camera 14 (see FIG. 1) of a merchandise item registration apparatus S (see FIG. 1) will be referred to as an “object”. Meanwhile, confirming a merchandise item as an object to be checked out will be referred to as “registering sales”. Further, registering image information obtained by imaging an object at the time of sales registration as reference image information to be used in identifying merchandise items thereafter will be referred to as “conducting additional registration”.

### First Embodiment

### Outline of a Merchandise Item Registration Apparatus

FIG. 1 is an external perspective view of a checkout system S as a merchandise item registration apparatus S according to a first embodiment. The merchandise item registration apparatus S is an apparatus for checking out merchandise items, and includes a merchandise item identification device 1 and a POS terminal 2.

The merchandise item identification device 1 identifies the merchandise item (or presents candidates) corresponding to an object from image information obtained by the camera 14 performing imaging, and registers sales through operation performed by an operator (a store clerk).

As shown in FIG. 1, the merchandise item identification device 1 is placed on a counter table C1. The merchandise item identification device 1 includes a thin housing H having a rectangular shape, a display/operation unit 12 placed on the housing H, a keyboard 123 adjacent to the display/operation unit 12, and a customer display 124 provided on a side of the display/operation unit 12. The camera 14 for imaging objects is installed in the housing H. A transparent read window W is formed in front of the camera 14.

Each of the objects in a basket K1 shown in FIG. 1 are taken out from the basket K1 by an operator, is brought to a spot in front of the camera 14, and is imaged by the camera 14. The result of object recognition based on the result of the imaging performed by the camera 14 is displayed on a display 121, and the operator performs an operation to confirm sales registration. After that, the object is transferred into another basket K2. In this manner, sales registration is performed on each object to be checked out. The object recognition will be described later.

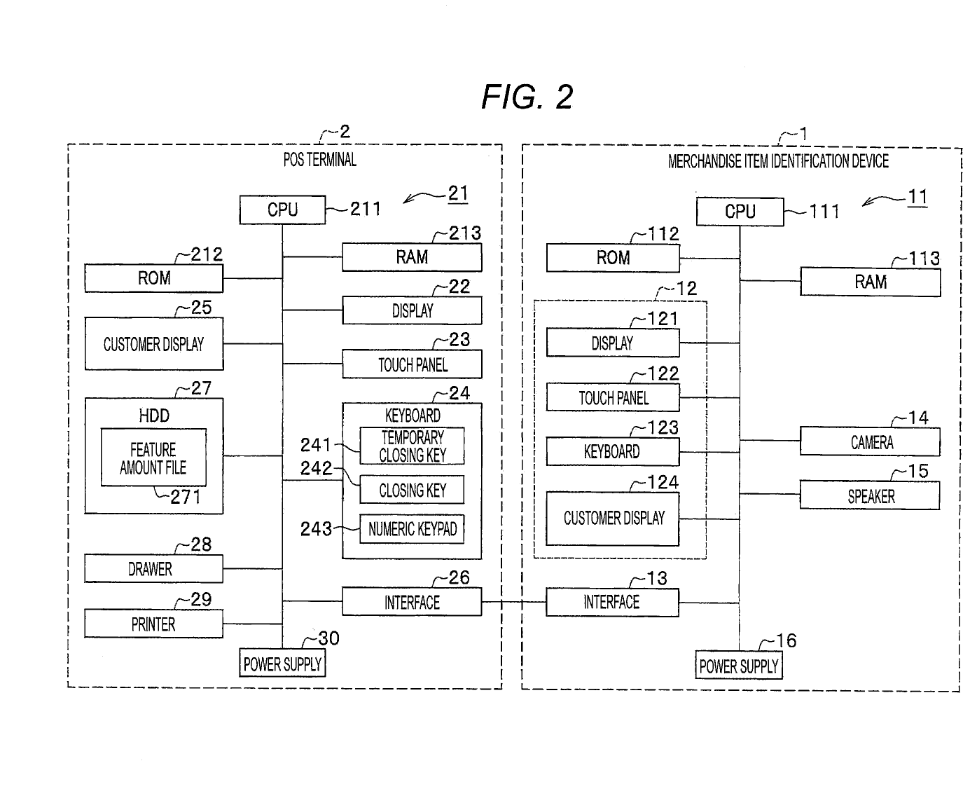

The POS terminal 2 is a terminal for checking out merchandise items, and is connected to the merchandise item identification device 1 in a communicable manner. As shown in FIG. 1, the POS terminal 2 is placed on a counter table C2. The POS terminal 2 includes a display 22, a keyboard 24, a customer display 25, a drawer 28, and a printer 29. The structures of the merchandise item identification device 1 and the POS terminal 2 are described below, with reference to FIG. 2.

FIG. 2 is a diagram showing the structures of the merchandise item identification device 1 and the POS terminal 2. The merchandise item identification device 1 includes a microcomputer 11, the display/operation unit 12, an interface 13, the camera 14, a speaker 15, and a power supply 16.

The microcomputer 11 (a control unit) controls the display/operation unit 12, the camera 14, the speaker 15, and the like in the merchandise item identification device 1, and includes a CPU 111 (Central Processing Unit), a ROM (Read Only Memory) 112, and a RAM (Random Access Memory) 113. The CPU 111, the ROM 112, and the RAM 113 are connected by a bus so that a program stored in the ROM 112 is read and loaded into the RAM 113, and the CPU 111 executes various kinds of processing.

The display/operation unit 12, the interface 13, the camera 14, the speaker 15, and the power supply 16 are connected to the CPU 111 via an internal bus and an input/output circuit (not shown).

The display/operation unit 12 includes the display 121, a touch panel 122, the keyboard 123, and the customer display 124. The display/operation unit 12 displays results and the like of object recognition performed on objects, and is controlled by the CPU 111.

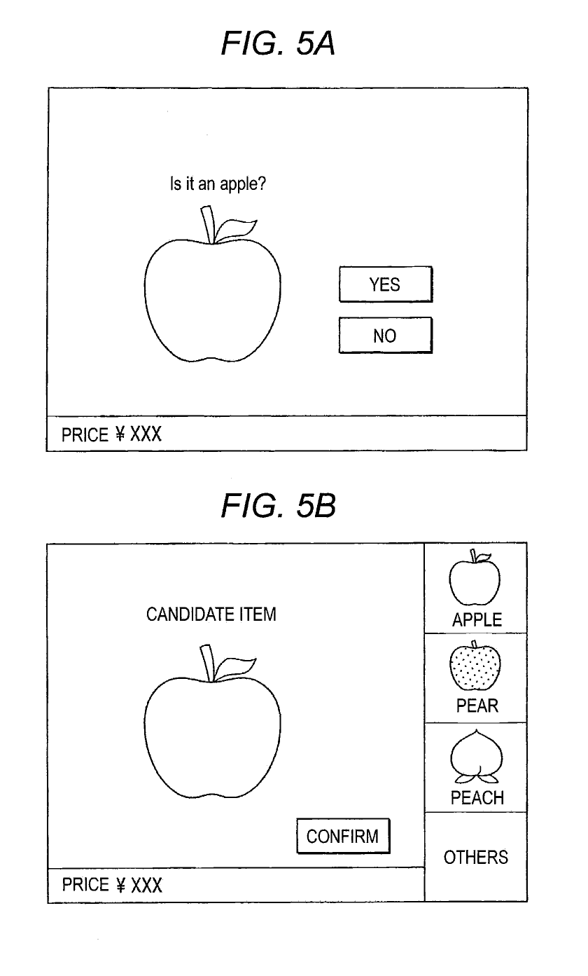

The display 121 (a display unit) displays information about a merchandise item to the operator in accordance with an instruction from the CPU 111. Specifically, the display 121 displays a result of object recognition performed on an object (see FIG. 5A), or displays one or more candidates for the corresponding merchandise item (see FIG. 5B).

The touch panel 122 (an input unit) accepts an operation related to the information displayed on the display 121. Specifically, the touch panel 122 accepts an input indicating whether an object is a predetermined merchandise item (an input of “Yes” or “No”, for example; see FIG. 5A), or accepts selection made by the operator from among candidates (such as “apple”, “pear”, and “peach”; see FIG. 5B) for an object. Information that is input through the touch panel 122 is transmitted to the POS terminal 2 via the interface 13.

The keyboard 123 (an input unit) accepts an operation from the operator, and includes operation keys. Specifically, the keyboard 123 accepts an input of the number of merchandise items from the operator, and accepts an input of the price of a merchandise item from the operator. Information that is input through the keyboard 123 is transmitted to the POS terminal 2 via the interface 13.

The customer display 124 presents predetermined information to a customer in accordance with an instruction from the CPU 111. Specifically, when the operator confirms sales registration of an object, the customer display 124 displays the name, the price, and the like of the confirmed object.

The interface 13 transmits and receives data between the merchandise item identification device 1 and the POS terminal 2. The interface 13 is connected to the bus in the merchandise item identification device 1, and is also connected to an interface 26 in the POS terminal 2.

The camera 14 (an imaging unit) images an object brought to a spot in front of the read window W (see FIG. 1) by the operator, and, as mentioned above, is installed in the housing H (see FIG. 1). The camera 14 is a color CCD image sensor, a color CMOS image sensor, or the like, and images an object in accordance with an instruction from the CPU 111.

The camera 14 captures a 30-fps moving image, for example. Frame images (image data) sequentially captured by the camera 14 at a predetermined frame rate are stored into the RAM 113.

The speaker 15 generates a predetermined sound in accordance with an instruction from the CPU 111. For example, every time sales registration of an object is confirmed by an operation performed by the operator through the touch panel 122, the speaker 15 generates a predetermined sound. Accordingly, sales registration of a merchandise item can be recognized from the sound generated from the speaker 15 as well as the display on the customer display 124.

The power supply 16 is a power supply for the respective components in the merchandise item identification device 1, and is connected to the respective components described above.

Based on a merchandise item ID sent from the merchandise item identification device 1, the POS terminal 2 records information about sales registration of the merchandise item corresponding to the merchandise item ID, such as the merchandise classification, the trade name, and the unit price of the merchandise item, into a sales master file (not shown) or the like. In this manner, sales registration is conducted. The POS terminal 2 includes a microcomputer 21, the display 22, a touch panel 23, the keyboard 24, the customer display 25, the interface 26, an HDD (Hard Disk Drive) 27, the drawer 28, the printer 29, and a power supply 30.

The microcomputer 21 controls the respective components in the POS terminal 2, and includes a CPU 211, a ROM 212, and a RAM 213. The CPU 211, the ROM 212, and the RAM 213 are connected by a bus so that a program stored in the ROM 212 is read and loaded into the RAM 213, and the CPU 211 executes various kinds of processing.

The display 22, the touch panel 23, the keyboard 24, the customer display 25, the interface 26, the HDD 27, the drawer 28, the printer 29, and the power supply 30 are connected to the CPU 211 via an internal bus and an input/output circuit (not shown).

The display 22 displays information about a merchandise item to the operator in accordance with an instruction from the CPU 211. The touch panel 23 accepts an operation related to the information displayed on the display 22.

The keyboard 24 includes a temporary closing key 241 to be pressed when sales registration is provisionally conducted (provisional checkout), a closing key 242 to be pressed when sales registration is conducted (checkout), and a numeric keypad 243 including numeric keys and various operator keys.

The customer display 25 presents predetermined information to a customer in accordance with an instruction from the CPU 211.

The interface 26 transmits and receives data between the POS terminal 2 and the merchandise item identification device 1. The interface 26 is connected to the bus in the POS terminal 2, and is also connected to the interface 13 in the merchandise item identification device 1.

A program and various kinds of files are stored in the HDD 27 (a storage unit). All or some of the program and the various files stored in the HDD 27 are copied into the RAM 213 when the POS terminal 2 is activated, and the program copied into the RAM 213 is executed by the CPU 211. A feature amount file 271 related to respective merchandise items is stored in the HDD 27. The feature amount file 271 is a merchandise item file in which information about sales registration of the respective merchandise items available and on display in the store is associated with reference image information about the respective merchandise items.

The drawer 28 is designed to hold cash and the like, and can be opened by a predetermined operation through the keyboard 24.

The printer 29 prints the details of a transaction related to merchandise items on a receipt in accordance with an instruction from the CPU 211.

The power supply 30 is a power supply for the respective components in the POS terminal 2, and is connected to the respective components described above.

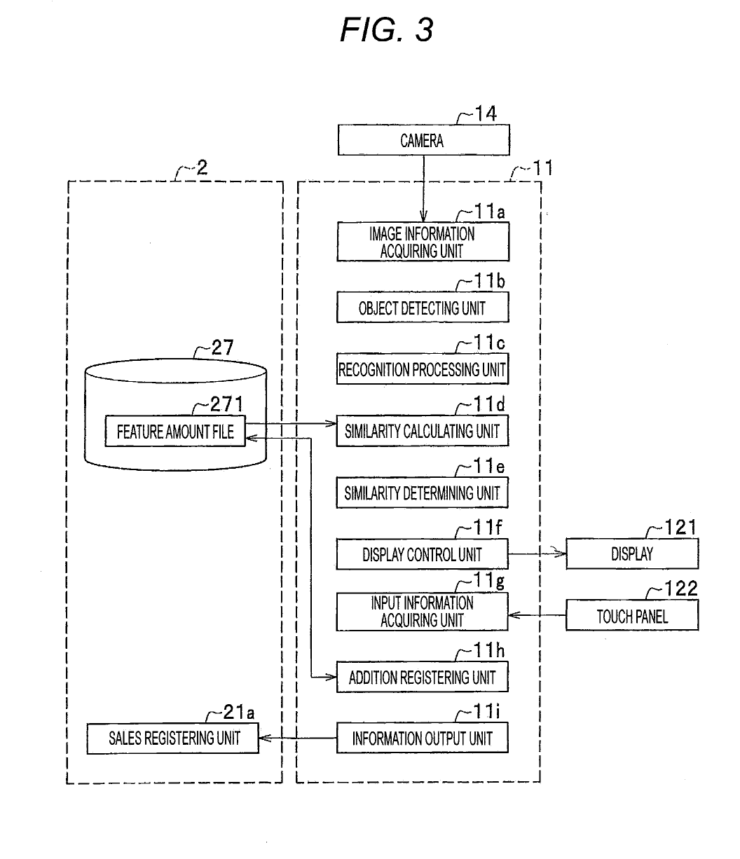

FIG. 3 is a functional block diagram including the microcomputer 11 of the merchandise item identification device 1. The microcomputer 11 includes an image information acquiring unit 11a, an object detecting unit 11b, a recognition processing unit 11c, a similarity calculating unit 11d, a similarity determining unit 11e, a display control unit 11f, an input information acquiring unit 11g, an addition registering unit 11h, and an information output unit 11i. The functions of the above described functions are embodied by the CPU 111 (see FIG. 2) of the merchandise item identification device 1 executing the program stored in the ROM 112 (see FIG. 2).

The image information acquiring unit 11a outputs an imaging on-state signal to the camera 14, and causes the camera 14 to perform imaging. The image information acquiring unit 11a sequentially acquires frame images (image data) obtained through the imaging of objects.

The image information acquiring unit 11a acquires the frame images in accordance with the sequence of the frame images stored in the RAM 113 (see FIG. 2).

Based on pattern matching or the like, the object detecting unit 11b detects all or some of the objects included in the frame images acquired by the image information acquiring unit 11a. For example, the object detecting unit 11b digitizes a frame image acquired by capturing an image of an object with the camera 14, and extracts the contour from the digitized image. The object detecting unit 11b then detects the object based on the contour.

The recognition processing unit 11c performs a recognition process based on object recognition from a frame image acquired by capturing an image of an object with the camera 14. That is, the recognition processing unit 11c has the function to recognize an object by extracting feature amounts as image information, such as the color, the shape (including irregularities of the surface), and the size of the object, from a frame image from which the object has been detected.

Recognizing an object included in an image in the above manner is called generic object recognition. In “The Current State and Future Directions on Generic Object Recognition” by Keiji Yanai, data set and evaluation benchmark tests are conducted by taking into account the surveys on generic object recognition studies, and future directions of generic object recognition are predicted:

Keiji Yanai, “The Current State and Future Directions on Generic Object Recognition”, [online] IPSJ Transaction, Nov. 15, 2007, Vol. 48, No. SIG16, pp. 1-24, [Retrieved on Sep. 8, 2014], on the Internet

A technique for performing generic object recognition by dividing an image into regions for respective objects is disclosed in the following literature:

Jamie Shotton, et al., “Semantic Texton Forests for Image Categorization and Segmentation”, Computer Vision and Pattern Recognition, 2008. CVPR 2008. IEEE Conference on, [retrieved on Sep. 8, 2014], on the Internet

The similarity calculating unit 11d calculates a degree of similarity between an object and each merchandise item by comparing the image information such as the feature amounts extracted as a result of the recognition performed by the recognition processing unit 11c with the reference image information about each corresponding merchandise item stored in the HDD 27. Here, a “degree of similarity” is a value indicating how similar an object is to a merchandise item in terms of image data. In a case where an image of an object is completely the same as an image of a merchandise item, the degree of similarity is 100%. In a case where an image of an object greatly differs from an image of a merchandise item, the degree of similarity is low.

The similarity determining unit 11e determines whether a degree of similarity calculated by the similarity calculating unit 11d is within a predetermined range.

Specifically, the similarity determining unit 11e determines whether the degree of similarity to the reference image information about the merchandise item having the highest degree of similarity to the image information about an object imaged by the camera 14 among the merchandise items having reference image information stored in the feature amount file 271 is within a first range (70% or higher, for example). The first range is set so that candidates for the merchandise item corresponding to the object can be narrowed down to the merchandise item having the highest similarity, and the operator will only need to confirm whether or not the object corresponds to the merchandise item.

That is, in a case where there are merchandise items having degrees of similarity to the object within the first range, the similarity determining unit 11e outputs the merchandise item ID or the like of the merchandise item having the highest degree of similarity to the display control unit 11f.

The similarity determining unit 11e also determines whether the degree of similarity between the image information about the object and the reference image information about each merchandise item is within a second range (50 to 70%, for example). The second range is set so that there is one or more merchandise items having a possibility of correspondence to the object, but any merchandise item will not be determined to correspond to the object.

In a case where there are no merchandise items having degrees of similarity to the object within the first range, but there is one or more merchandise items falling within the second range, the similarity determining unit 11e outputs the merchandise item ID(s) or the like of the corresponding merchandise item(s) to the display control unit 11f.

The similarity determining unit 11e also determines whether the degree of similarity between an image of an object and an image of a merchandise item is within a third range (lower than 50%, for example). The third range is set so that no merchandise items similar to the object will not be found.

In a case where there exist only merchandise items having degrees of similarity to the object within the third range (or where there are no merchandise items falling within the first range or the second range), the similarity determining unit 11e outputs information to that effect to the display control unit 11f.

The display control unit 11f displays a predetermined screen on the display 121 based on a determination result from the similarity determining unit 11e.

Specifically, in a case where there is a merchandise item having a degree of similarity to the object within the first range (70% or higher, for example), the display control unit 11f causes the display 121 to display a confirmation screen related to the merchandise item (see FIG. 5A).

In a case where there are merchandise items having degrees of similarity to the object within the second range (50 to 70%, for example), the display control unit 11f causes the display 121 to display a select screen related to the merchandise items as candidate merchandise items (see FIG. 5B).

In a case where there exist only merchandise items having degrees of similarity to the object within the third range (lower than 50%, for example), the display control unit 11f causes the display 121 to display an error message to the effect that any merchandise item similar to the object has not been found.

The input information acquiring unit 11g has the function to accept an operation from the operator via the touch panel 122. Specifically, in a case where the above mentioned confirmation screen (FIG. 5A) is displayed on the display 121, the input information acquiring unit 11g accepts an input as to whether the object corresponds to the displayed merchandise item.

In a case where the above mentioned select screen (FIG. 5B) is displayed on the display 121, the input information acquiring unit 11g accepts an input as to selection from among candidate merchandise items.

In a case where the merchandise item corresponding to the object is identified from among candidate merchandise items by an operation through the touch panel 122, the addition registering unit 11h conducts additional registration of the image information about the object as the reference image information about the corresponding merchandise item so that the object is included in a category of the corresponding merchandise item. Specifically, in a case where one merchandise item is selected from among merchandise items having degrees of similarity to the object within the second range (50 to 70%, for example), the addition registering unit 11h conducts additional registration so that the object will be included in the merchandise item (or the object will be determined to have a degree of similarity equal to or higher than 70%) thereafter. The addition registering unit 11h then stores information about the additional registration into the feature amount file 271. The processing related to the additional registration will be described later in detail.

The information output unit 11i has the function to output the information acquired by the input information acquiring unit 11g to the POS terminal 2. Specifically, the information output unit 11i outputs the merchandise item ID or the like of the merchandise item confirmed or selected by the operator through the touch panel 122, to a sales registering unit 21a of the POS terminal 2. In a case where a merchandise item is selected from a merchandise item list through the keyboard 123 (see FIG. 2), the information output unit 11i outputs the merchandise item ID or the like of this merchandise item to the POS terminal 2.

The sales registering unit 21a of the POS terminal 2 has the function to register the sales of the merchandise item confirmed or selected by the operator. The result of the sales registration by the sales registering unit 21a is stored into the HDD 27, and is printed on a receipt by the printer 29 (see FIG. 2).

(Operation of the Merchandise Item Registration Apparatus)

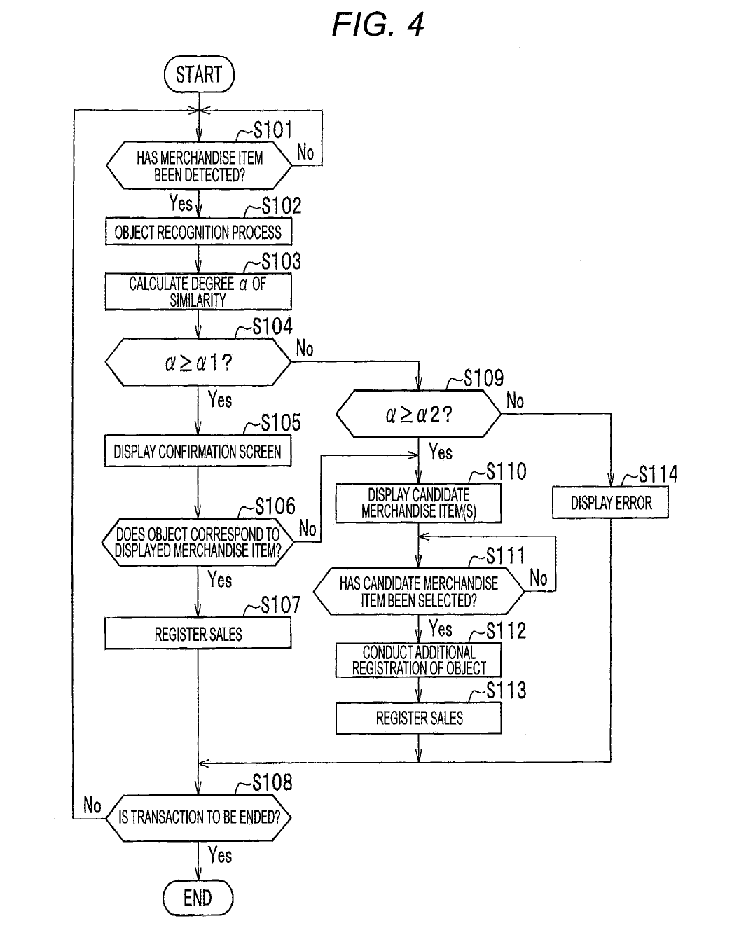

FIG. 4 is a flowchart showing a merchandise item registration process based on object recognition to be performed by the merchandise item registration apparatus S. The series of procedures shown in FIG. 4 are carried out while an object (a merchandise item) in the basket K1 (see FIG. 1) is being checked out in an operation being performed by an operator.

In step S101, the merchandise item registration apparatus S determines whether an object has been detected by the object detecting unit 11b. Specifically, as the operator holds an object in front of the read window W (see FIG. 1), the camera 14 images the object, and the object detecting unit 11b detects the object based on the image data obtained as a result of the imaging.

If the object has been detected in step S101 (S101: Yes), the merchandise item registration process moves on to step S102. If the object has not been detected (S101: No), the merchandise item registration apparatus S repeats the procedure in step S101.

In step S102, the recognition processing unit 11c of the merchandise item registration apparatus S performs an object recognition process (recognition processing step). Specifically, the merchandise item registration apparatus S extracts feature amounts as image information, such as the color, the shape, the size, and the like of the object, from the image data of the object obtained through the imaging performed by the camera 14.

In step S103, the similarity calculating unit 11d of the merchandise item registration apparatus S calculates the degree a of similarity between the object imaged by the camera 14 and each merchandise item registered in the feature amount file 271 (similarity calculation step). That is, the merchandise item registration apparatus S calculates degrees a of similarity between the image information about object imaged by the camera 14 and the reference image information about the respective merchandise items registered in the feature amount file 271.

In step S104, the similarity determining unit 11e of the merchandise item registration apparatus S determines whether there are merchandise items having degrees a of similarity to the object that are equal to or higher than a threshold value α1 (70%, for example). It should be noted that the range not lower than the threshold value α1 is equivalent to the above described “first range”. If there exist merchandise items having degrees a of similarity equal to or higher than the threshold value α1 (S104: Yes), the process being performed by the merchandise item registration apparatus S moves on to step S105.

In step S105, the display control unit 11f of the merchandise item registration apparatus S causes the display 121 to display a confirmation screen showing an image of the merchandise item having the highest degree a of similarity. FIG. 5A shows an example of the confirmation screen displayed on the display 121.

This is an example case where feature amounts based on the image data of a red apple are stored as reference image information associated with the merchandise item “apple” in the feature amount file 271. If the object imaged by the camera 14 is a red apple similar to the merchandise item registered in the feature amount file 271, and the degree a of similarity is equal to or higher than the threshold value α1 (S104: Yes), the confirmation screen shown in FIG. 5A is displayed on the display 121. That is, an image of an “apple” is displayed as the merchandise item having the highest degree a of similarity, together with select buttons “Yes” and “No”.

In step S106, the merchandise item registration apparatus S determines whether an indication to the effect that the object corresponds to the merchandise item displayed on the display 121 has been input. Specifically, the merchandise item registration apparatus S determines whether “Yes” or “No” shown in FIG. 5A has been selected through an operation performed by the operator.

If “Yes” (see FIG. 5A) has been selected by the operator, or where the object corresponds to the merchandise item “apple” displayed on the display 121 (S106: Yes), the merchandise item registration process moves on to step S107.

If “No” (see FIG. 5A) has been selected by the operator, or where the object does not correspond to the merchandise item “apple” displayed on the display 121 (S106: No), on the other hand, the merchandise item registration process moves on to step S110.

In step S107, the merchandise item registration apparatus S conducts sales registration on the object (such as an apple) as a merchandise item. Specifically, the merchandise item registration apparatus S transmits the merchandise item ID and the like of the merchandise item displayed in step S106 from the merchandise item identification device 1 to the POS terminal 2.

In step S108, the merchandise item registration apparatus S determines whether to end the transaction of merchandise items (a series of sales registration operations). If a transaction end instruction is issued from the operator (S108: Yes), the merchandise item registration apparatus S ends the merchandise item registration process (END). If any transaction end instruction has not been issued from the operator (S108: No), the merchandise item registration process returns to step S101.

If there are no merchandise items having degrees a of similarity to the object equal to or higher than the threshold value α1 (70%, for example) in step S104 (S104: No), the merchandise item registration process moves on to step S109.

In step S109, the similarity determining unit 11e of the merchandise item registration apparatus S determines whether there are merchandise items having degrees a of similarity to the object that are equal to or higher than a threshold value α2 (50%, for example) but lower than the threshold value α1 (70%, for example). It should be noted that the range equal to or higher than the threshold value α2 but lower than the threshold value α1 is equivalent to the above described “second range”.

If there exist merchandise items having degrees a of similarity to the object equal to or higher than the threshold value α2 but lower than the threshold value α1 (S109: Yes), the merchandise item registration process moves on to step S110. For example, there might be a case where reference image information based on the image data of a red apple under the merchandise item “apple” in the feature amount file 271 is registered in the HDD 27, but any reference image information based on the image data of apples in the other colors is not registered. In such a case, there is a high possibility that the degree of similarity between a green apple as the object and the merchandise item “apple” falls within the range equal to or higher than the threshold value α2 but lower than the threshold value α1.

In step S110, the display control unit 11f of the merchandise item registration apparatus S causes the display 121 to display one or more candidate merchandise items (display control step).

FIG. 5B shows an example of the select screen displayed on the display 121. The object imaged by the camera 14 is a green apple, for example. In the example shown in FIG. 5B, “apple” (the reference image information thereof is based on the image data of a red apple), “pear”, and “peach” are displayed as the candidate merchandise items on the right side of the screen. In the center of the screen, the merchandise item “apple” selected by the operator from among the candidate merchandise items on the right side is displayed.

In step S111 in FIG. 4, the merchandise item registration apparatus S determines whether one of the candidate merchandise items has been selected. Specifically, the merchandise item registration apparatus S determines whether the “confirm” button has been pressed with respect to the merchandise item selected by the operator (the selected item is the merchandise item “apple” in FIG. 5B).

In step S112, the addition registering unit 11h of the merchandise item registration apparatus S performs additional registration of the merchandise item (additional registration step). Specifically, the merchandise item registration apparatus S conducts additional registration of image information such as feature amounts obtained from the image data of the object (a green apple, for example) as a piece of the reference image information indicating the merchandise item (an apple, for example) selected in step S111.

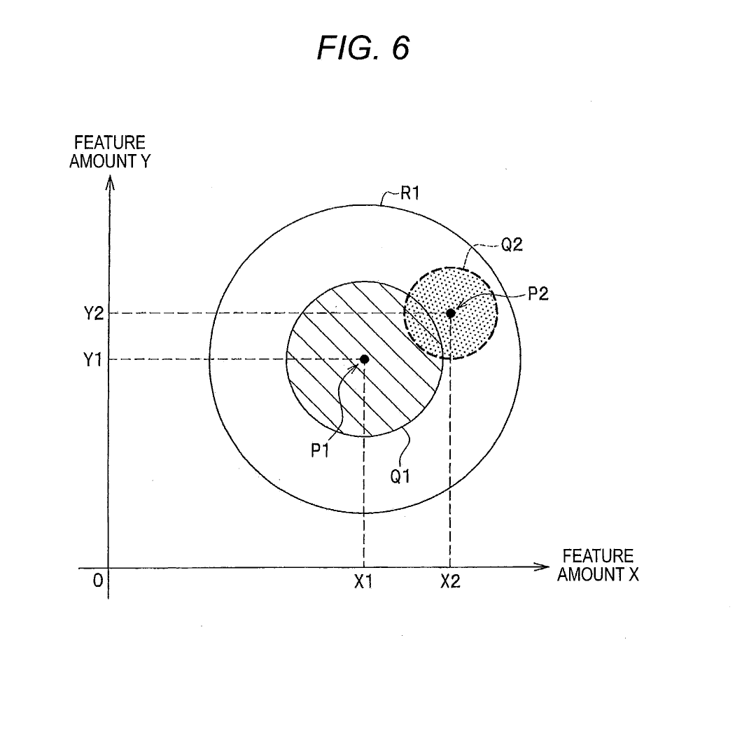

FIG. 6 is a diagram for explaining additional registration to be performed by the merchandise item registration apparatus S. The abscissa axis (feature amount X) in the explanatory diagram in FIG. 6 is the feature amount indicating the color of a merchandise item, for example, and the ordinate axis (feature amount Y) is the feature amount indicating the shape of the merchandise item, for example. It should be noted that FIG. 6 is a two-dimensional schematic diagram, and the number of dimensions of feature amounts is not limited to that shown in FIG. 6.

That is, feature amounts X1 and Y1 shown in FIG. 6 form a conceptual diagram of the reference image information amount this merchandise item (a red apple, for example). Point P1 represents the feature vectors corresponding to the above described reference image information. A region Q1 (the area shaded with lines) is the region in which degrees of similarity to the merchandise item (an apple, for example) are equal to or higher than the threshold value α1 (70%, for example), and is set in advance.

A region R1 is the region in which degrees of similarity to the merchandise item is equal to or higher than the threshold value α2 (50%, for example) but lower than the threshold value α1 (70%, for example). Point P2 defined by feature amounts X2 and Y2 represents the feature vectors of the object (a green apple, for example) to be additionally registered as a merchandise item in step S112.

In step S112 described above, the merchandise item registration apparatus S newly adds a predetermined region Q2 including the point P2 corresponding to the image of the object as the region in which degrees of similarity to the merchandise item are equal to or higher than the threshold value α1. With this, the region in which degrees of similarity to the merchandise item are equal to or higher than the threshold value α1 is expanded to the region defined by the sum set of the regions Q1 and Q2. Accordingly, in a case where a green apple (the object) is imaged by the camera 14 after the green apple as the object is additionally registered, the confirmation screen shown in FIG. 5A, not the select screen shown in FIG. 5B, is displayed.

That is, the operator only needs to determine whether the green apple corresponds to “apple”, and does not need to perform a complicated operation to select a merchandise item from among the merchandise items (apple, pear, and peach) as shown in the select screen in FIG. 5B, and further perform a confirming operation. Accordingly, the load on the operator can be made lighter than those in conventional cases, and it is easy to additionally register green apple as the merchandise item “apple”.

In this manner, apples having various features (green apples, large apples, and the like) are additionally registered as the merchandise item “apple”, and the region in which degrees of similarity are equal to or higher than the threshold value α1 (this region is formed with the regions Q1 and Q2 in FIG. 6) is gradually expanded.

Referring back to FIG. 4, explanation of the merchandise item registration process is continued.

In step S113, the merchandise item registration apparatus S conducts sales registration of the merchandise item (or the object) selected in step S111, and transmits the merchandise item ID and the like of the merchandise item from the merchandise item identification device 1 to the POS terminal 2.

If degrees a of similarity are equal to or lower than the threshold value α2 in step S109 (S109: No), the merchandise item registration process moves on to step S114. In step S114, the merchandise item registration apparatus S causes the display 121 to display a message “No matching items have been found”, for example. In this case, the operator cancels additional registration by performing an operation through the keyboard 123 or the like, and selects the merchandise item corresponding to the object from a merchandise item list allotted to the keyboard 123, for example.

In this embodiment, when a merchandise item is selected by the operator from among merchandise items having degrees of similarity to the object equal to or higher than the threshold value α2 but lower than the threshold value α1, additional registration is conducted so that the degree of similarity of the object to the selected merchandise item becomes equal to or higher than the threshold value α1. After the same object is imaged by the camera 14, the operator only needs to confirm whether or not the object corresponds to the merchandise item (by choosing “Yes” or “No”). Accordingly, the load on the operator can be made lighter than those in conventional cases.

The above described additional registration is automatically conducted in accordance with sales registration conducted by the operator (making a selection on the select screen shown in FIG. 5B).

Specifically, when sales registration of an object (such as a green apple) that is slightly different from the reference image information (such as a red apple) of the merchandise item is conducted, additional registration of the object is conducted at the same time. Accordingly, apples having various features relative to the merchandise item “apple” can be additionally registered as apples that can be recognized as objects without any difficulties.

Also, in the course of additional registration, the region in which degrees of similarity are equal to or higher than the threshold value α1 (this region is formed with the regions Q1 and Q2 shown in FIG. 6) is gradually expanded. As a result, display of the select screen shown in FIG. 5B becomes less and less frequent. Accordingly, the load on the operator conducting sales registration can be reduced.

### Second Embodiment

A second embodiment differs from the first embodiment in that merchandise items having different features from each other (a red apple and a green apple, for example) are additionally registered as different merchandise items, but the other principal aspects (the structures of the merchandise item identification device 1 and the POS terminal 2 shown in FIGS. 1 through 3) are the same as those of the first embodiment. Therefore, in the description below, different aspects from the first embodiment will be explained, but the same aspects as the first embodiment will not be explained.

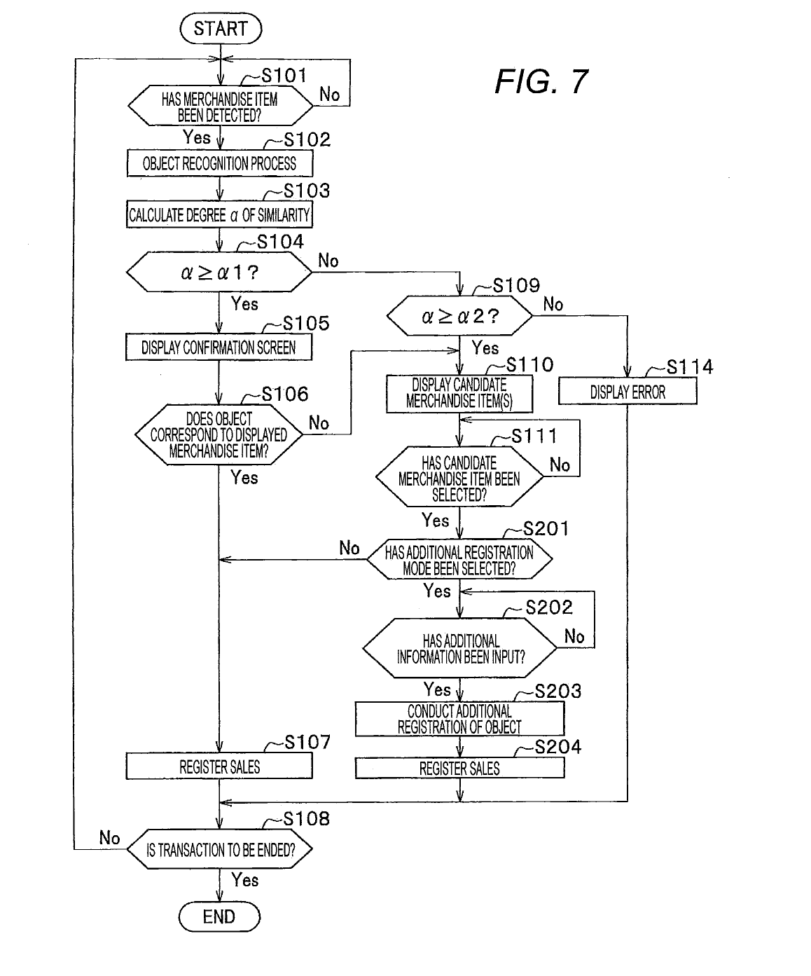

FIG. 7 is a flowchart showing a merchandise item registration process based on object recognition to be performed by the merchandise item registration apparatus S.

Steps S101 through S111 and step S114 in FIG. 7 are the same as those in the first embodiment (see FIG. 4), and therefore, explanation of them is not repeated herein.

If a merchandise item has been selected by the operator from among the candidate merchandise items in step S111 (S111: Yes), the merchandise item registration process moves on to step S201.

In step S201, the merchandise item registration apparatus S determines whether “additional registration mode” has been selected through an operation performed by the operator. The “additional registration mode” is the mode for inputting the visual feature (color) of a green apple as the object, and additionally registering the green apple as a different merchandise item from “red apple”. The select button for the additional registration mode is displayed in the select screen shown in FIG. 5B, for example, and the additional registration mode starts when the operator touches the button.

If the additional registration mode has been detected in step S201 (S201: Yes), the merchandise item registration process moves on to step S202. If the additional registration mode has not been selected but the “confirm” button (see FIG. 5B) is pressed (S201: No), the merchandise item registration apparatus S conducts sales registration in step S107.

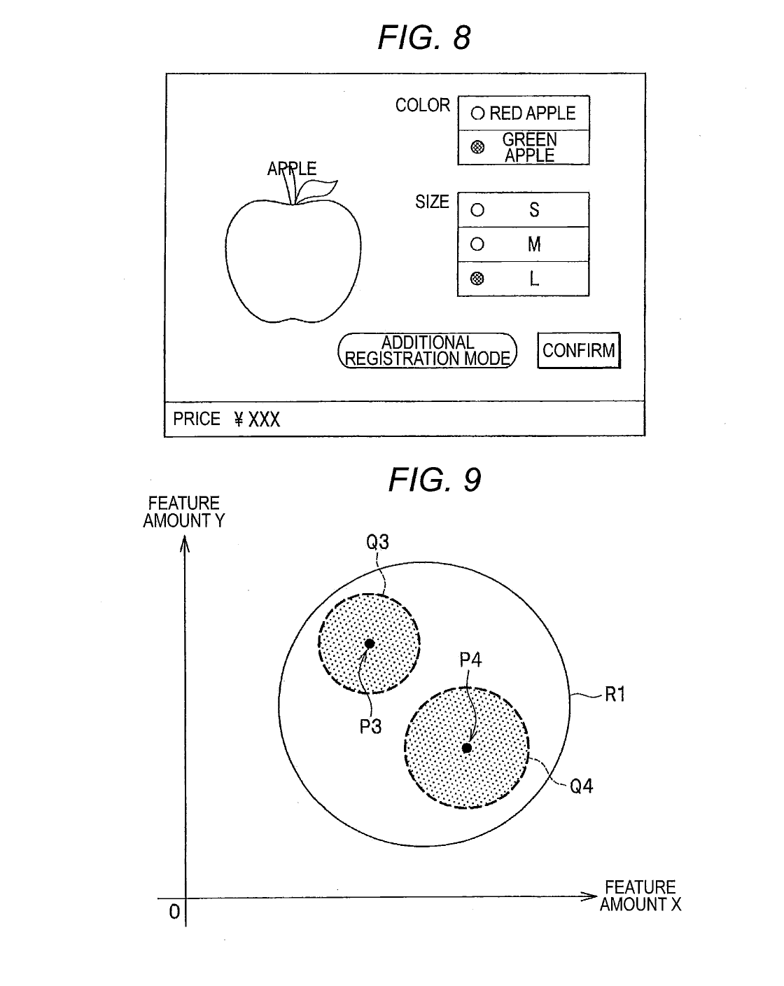

FIG. 8 is an example of a display screen in the additional registration mode. The object imaged by the camera 14 is a relatively large green apple, for example.

In the example shown in FIG. 8, select buttons for colors (red apple and green apple) and sizes (S, M, and L) are displayed on the side of an illustrated image of the merchandise item “apple”.

Which features are to be displayed among the features (the color, the size, the shape, and the like) of each merchandise item is determined in advance. The design may be changed so that it becomes possible to select a feature related to the size of a merchandise item, or change the trade name or the price or the like of a merchandise item.

In step S202 in FIG. 7, the merchandise item registration apparatus S determines whether additional information has been input through an operation performed by the operator. Here, the “additional information” is information including not only the external features such as the color, the shape, and the size of a merchandise time, but also the trade name, the unit price, and the like of the merchandise item. In the example shown in FIG. 8, a color and a size of a merchandise item can be selected.

If additional information has been input through an operation performed by the operator (S202: Yes), the merchandise item registration process moves on to step S203. If any additional information has not been input through an operation performed by the operator (S202: No), the merchandise item registration apparatus S repeats the procedure in step S202.

In step S203, the addition registering unit 11h of the merchandise item registration apparatus S performs additional registration related to the object (additional registration step).

In the example shown in FIG. 8, “green apple” has been selected with respect to color, and “size L” has been selected with respect to size. When the “confirm” button is pressed in this situation, the object is additionally registered not as the merchandise item “apple” but as a merchandise item “green apple of size L”.

FIG. 9 is a diagram for explaining additional registration to be performed by the merchandise item registration apparatus S. The abscissa axis (feature amount X) in the explanatory diagram shown in FIG. 9 indicates the color of a merchandise item, for example. The ordinate axis (feature amount Y) indicates the size of the merchandise item, for example. The region R1 shown in FIG. 9 is the region of the merchandise item “apple” including red apples, green apples, and apples of sizes S, M, and L.

For example, in a case where the feature vectors of an object (a green apple of size L) imaged by the camera 14 exist at point P3, the merchandise item registration apparatus S additionally registers a predetermined region Q3 including the point P3 as the merchandise item “green apple of size L”.

For example, in a case where the feature vectors of an object (a red apple of size M) imaged by the camera 14 exist at point P4, the merchandise item registration apparatus S additionally registers a predetermined region Q4 including the point P4 as “red apple of size M”.

In this manner, apples having different features are additionally registered so that the apples can be distinguished from one another. When additional registration is conducted, different merchandise item IDs from that allotted to the merchandise item “apple” are allotted to the merchandise items corresponding to the regions Q3 and Q4. The merchandise item IDs and image information such as the feature amounts for specifying the regions Q3 and Q4 are then stored as reference image information into the feature amount file 271. Accordingly, when a green apple of size L is imaged as an object by the camera 14 thereafter, this object will be recognized not as “apple” but as “green apple of size L”.

After the additional registration is conducted in step S203 in FIG. 7, the merchandise item registration apparatus S in step S204 conducts sales registration with respect to the object, which is the green apple of size L.

According to this embodiment, merchandise items stored as a single merchandise item (such as “apple”) in the feature amount file 271 can be additionally registered as different merchandise items accompanied by additional information. The data of the respective merchandise items particularly classified by the additional registration is then accumulated in the HDD 27. Accordingly, the feature amount file 271 after the additional registration can be used as the data in carrying out an analysis to determine what features the merchandise items with excellent sales have, for example.

Also, as the operator successively make selections from among feature-related options, the above described additional registration is sequentially conducted. Accordingly, additional registration of merchandise items can be readily conducted, and the load on the operator conducting additional registration can be reduced.

### Third Embodiment

A third embodiment differs from the first embodiment particularly in that the merchandise item code of an object is acquired by an item code acquiring unit (not shown), and additional registration of the merchandise item corresponding to the merchandise item code is conducted. In the description below, different aspects from the first embodiment will be explained, but the same aspects as the first embodiment will not be explained.

The microcomputer 11 (see FIG. 2) of a merchandise item registration apparatus S according to this embodiment includes an item code acquiring unit (not shown) that reads the merchandise item code attached to an object from the image data of the object imaged by the camera 14. The above described merchandise item code is information for uniquely identifying a merchandise item, such as a bar code or a QR code (a registered trade name).

In the description below, processing in a case where a merchandise item code has been read by the item code acquiring unit (not shown) is explained. However, in a case where any merchandise item code has not been read, a merchandise item registration process based on object recognition (see FIG. 4) is performed as in the first embodiment.

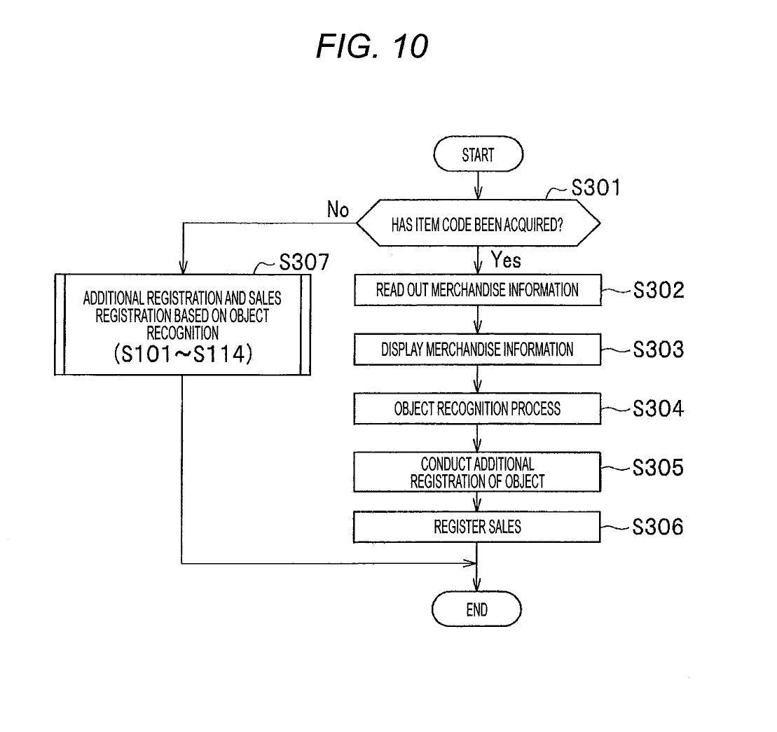

FIG. 10 is a flowchart showing a merchandise item registration process to be performed by the merchandise item registration apparatus S.

In step S301, the merchandise item registration apparatus S determines whether the merchandise item code attached to an object has been read by the item code acquiring unit (not shown) from the image data of the object imaged by the camera 14, or whether the merchandise item code of the object has been acquired. If a merchandise item code is attached to the object and has been successfully read (S301: Yes), the merchandise item registration process moves on to step S302. As the merchandise item code is acquired in this manner, to which merchandise item the merchandise item code and the object imaged by the camera 14 correspond can be uniquely determined.

In step S302, the merchandise item registration apparatus S reads, from the HDD 27, the merchandise item information corresponding to the merchandise item code acquired in step S301. The merchandise item information read here is an illustrated image of the merchandise item, the merchandise item ID, the merchandise classification, the trade name, the unit price, and the like, and is associated with the merchandise item code in the HDD 27. Although not read in step S302, the merchandise item information stored in the HDD 27 also includes reference image information and the like.

The procedure in step S302 is the read process for displaying the merchandise item information to the operator for confirmation, and the operator does not need to perform any predetermined operation. This is because the merchandise item corresponding to the object has already been uniquely identified by the merchandise item code (S301).

Accordingly, false registration of merchandise items can be avoided, and the load on the operator can be made lighter than that in a case where the operator visually confirms or selects each merchandise item.

In step S303, the merchandise item registration apparatus S causes the display 121 to display the above described merchandise item information. For example, the merchandise item registration apparatus S causes the display 121 to display not only an illustrated image of the merchandise item but also the trade name, the unit price, and the like of the merchandise item.

In step S304, the recognition processing unit 11c of the merchandise item registration apparatus S performs an object recognition process, and extracts the merchandise item code and image information such as feature amounts from the image data of the object imaged by the camera 14. The object recognition process is the same as the procedure in step S102 (see FIG. 4) described in the first embodiment.

In step S305, the merchandise item registration apparatus S additionally registers the image information about the object as a piece of reference image information. That is, the merchandise item registration apparatus S performs additional registration so that the object (such as an apple) is included in the merchandise item (such as “apple”) corresponding to the merchandise item code acquired in step S301.

In the third embodiment, image information based on the image data obtained while objects are identified based on merchandise item codes is accumulated as the reference image information about the merchandise items identified from the merchandise item codes, so that the merchandise item registration apparatus S learns to accurately identify each of merchandise items slightly different in color, shape, size, and the like, through object recognition.

Also, in the third embodiment, the merchandise item registration apparatus S prioritizes identification of merchandise items based on merchandise item codes over identification of merchandise items based on object recognition. That is, in a case where a merchandise item code is attached to an object imaged by the camera 14, merchandise item identification from the merchandise item code is prioritized over merchandise item identification through object recognition. This is because the correspondence relationship between the merchandise item code and the merchandise item has higher reliability than a result of object recognition.

The additional registration of the object in step S305 is the same as the procedure in step S112 (see FIG. 4) described in the first embodiment.

As the additional registration is performed in the above manner, an object can be appropriately identified based on object recognition even if any merchandise item code is not attached to the object during sales registration (or any merchandise item code is not read) thereafter. For example, in a case where a green apple as an object is additionally registered as the merchandise item “apple”, and thereafter, the same object (a green apple) is imaged but any merchandise item code is not read, the object can be identified as the merchandise item “apple” based on object recognition.

As a result, the confirmation screen (see FIG. 5A) for the merchandise item is displayed on the display 121, and accordingly, the operator can skip the operation to select the merchandise item “apple” from among merchandise items (see FIG. 5B).

After the additional registration is conducted in step S305 in FIG. 10, the merchandise item registration apparatus S in step S306 conducts sales registration of the merchandise item. Specifically, the merchandise item registration apparatus S transmits the merchandise item ID and the like of the merchandise item acquired in step S301 from the merchandise item identification device 1 to the POS terminal 2.

If the merchandise item code of the object has not been acquired in step S301 (S301: No), the merchandise item registration process moves on to step S307. In step S307, the merchandise item registration apparatus S conducts additional registration and sales registration of the merchandise item based on object recognition. The procedure in step S307 is the same as the procedures in steps S101 through S114 (see FIG. 4) described in the first embodiment, and therefore, explanation of that is not repeated herein.

According to this embodiment, in a case where a merchandise item code has been acquired by the item code acquiring unit (not shown), errors in sales registration can be prevented, as the merchandise item code is prioritized over a result of object recognition in identifying a merchandise item.

Also, in a case where a merchandise item code has been read, the operator does not need to perform any operation on a confirmation screen (see FIG. 5A) or a select screen (see FIG. 5B). Accordingly, the load on the operator conducting sales registration can be greatly reduced.

Also, image information based on the image data obtained while objects are identified based on merchandise item codes is accumulated as the reference image information about the merchandise items identified from the merchandise item codes, so that merchandise items slightly different in color, shape, size, and the like can be accurately distinguished from one another through object recognition based on a wide variety of reference image information even if any of the merchandise item codes has not been read.

[Modifications]

Although merchandise item registration apparatuses S according to the present invention have been described through the respective embodiments, the present invention is not limited to these embodiments, and various modifications can be made to them.

For example, in a case where there exist merchandise items having degrees of similarity to the object equal to or higher than the threshold value α1 (70%, for example) (Yes in S104 in FIG. 4) in the first embodiment, the display control unit 11f causes the display 121 to display a confirmation screen (see FIG. 5A). However, the present invention is not limited to that. Specifically, the threshold value α1 may be made sufficiently higher (90%, for example) so that sales registration is conducted without any operator performing a confirming operation.

Also, in the second embodiment, an operator is asked to determine whether to start the additional registration mode (S201 in FIG. 7). However, the present invention is not limited to that. Specifically, every time a merchandise item corresponding to an object is selected (Yes in S111 in FIG. 7), additional information about the merchandise item may be displayed on the display 121. The additional information about each merchandise item may be displayed as options as shown in FIG. 8, or may be input in a blank by an operator.

Also, information about the color of an object acquired when object recognition is performed may be added as the above described additional information by the addition registering unit 11h. With this, the operator does not need to take the trouble of inputting color-related additional information.

The above described embodiments can be combined as appropriate. For example, the second embodiment and the third embodiment may be combined, to perform the following process. In a case where the merchandise item code of an object has been acquired by the item code acquiring unit (not shown), the microcomputer 11 may identify the merchandise item and the additional information corresponding to the merchandise item code, rather than identifying candidate merchandise items based on object recognition. The object is then additionally registered as the merchandise item having the additional information.

For example, in a case where a red apple and a green apple are to be additionally registered as different merchandise items, the operator attaches different bar codes to the red apple and the green apple. The additional information including not only the colors of the merchandise items but also the merchandise item IDs, the trade names, the unit prices, and the like of the respective merchandise items is associated with the bar codes and is stored in the HDD 27.

It should be noted that there is no need to attach bar codes to all the red apples and green apples in the store. Instead, one bar code is attached to a red apple, and another bar code is attached to a green apple. This is because, once additional registration based on additional information is conducted, the respective merchandise items can be identified through object recognition thereafter.

Red apples and green apples that are objects are then additionally registered as merchandise items accompanied by the additional information. As a result, “apple”, which has been regarded as one merchandise item, can be classified into “red apple” and “green apple”, and the sales data and the like of the respective merchandise items can be accumulated.

The processes described in the respective embodiments (see FIGS. 4, 7, and 10) may be performed by another computer executing a program. The program can be provided via a communication network, or may be recorded in recording media such as CD-ROMs to be distributed.

What is claimed is:

1. A merchandise item registration apparatus comprising:
an item code acquiring unit configured to read a merchandise item code associated with an object to be identified;
an image information acquiring unit configured to acquire image information about the object to be identified by imaging the object to be identified at a time of sales registration; and
an identifying unit configured to identify a merchandise type of the object to be identified based on the read merchandise item code when the merchandise item code is successfully read by the item code acquiring unit, and associate the image information acquired by the image information acquiring unit with the identified merchandise type, the image information being accumulated as a piece of a plurality of pieces of reference image information to be referred to at a time of merchandise type identification based on object recognition.

2. The merchandise item registration apparatus according to claim 1, wherein, when the merchandise item code is not successfully read by the item code acquiring unit, the identifying unit identifies the merchandise type of the object to be identified based on the object recognition.

3. The merchandise item registration apparatus according to claim 2, wherein,
when the merchandise type of the object to be identified is to be identified based on the object recognition, and degrees of similarity of some of the pieces of the reference image information to the image information about the object to be identified acquired by the image information acquiring unit are equal to or higher than a first threshold value,
the identifying unit identifies a merchandise type corresponding to the piece of the reference image information having the highest degree of similarity as the merchandise type of the object to be identified.

4. The merchandise item registration apparatus according to claim 3, wherein the identifying unit displays an image of the identified merchandise type on a display.

5. The merchandise item registration apparatus according to claim 3, wherein,
when the merchandise type of the object to be identified is to be identified based on the object recognition, and the degrees of similarity of the accumulated pieces of the reference image information are neither equal to nor higher than the first threshold value while the degrees of similarity of some of the pieces of the reference image information fall within a range of a second threshold value to the first threshold value, the some of the pieces of the reference image information being regarded as merchandise types
the identifying unit displays images of the respective merchandise types as candidate merchandise types for the object to be identified on a display.

6. The merchandise item registration apparatus according to claim 5, wherein the identifying unit displays the candidate merchandise types in a line on the display.

7. The merchandise item registration apparatus according to claim 5, wherein,
when one of the candidate merchandise types displayed on the display is selected as the merchandise type of the object to be identified,
the identifying unit accumulates the image information acquired by the image information acquiring unit as one of the pieces of the reference image information to be referred to at a time of merchandise type identification based on the object recognition, the image information being associated with the selected merchandise type.

8. A merchandise item registration apparatus comprising:
a camera configured to image one of an object to be identified and a merchandise item code attached to the object to be identified;
an item code acquiring unit configured to read the merchandise item code attached to the object to be identified based on image information about the merchandise item code imaged by the camera; and
an identifying unit configured to identify a merchandise type of the object to be identified based on the read merchandise item code when the merchandise item code is successfully read by the item code acquiring unit, and associate image information about the object to be identified imaged by the camera with the identified merchandise type, the image information about the object to be identified being accumulated as a piece of a plurality of pieces of reference image information to be referred to at a time merchandise type identification based on object recognition.

9. The merchandise item registration apparatus according to claim 8, wherein, when the merchandise item code is not successfully read by the item code acquiring unit, the identifying unit identifies the merchandise type of the object to be identified based on the object recognition.

10. The merchandise item registration apparatus according to claim 9, wherein,
when the merchandise type of the object to be identified is to be identified based on the object recognition, and degrees of similarity of some of the pieces of the reference image information to the image information about the object to be identified imaged by the camera are equal to or higher than a first threshold value,
the identifying unit identifies a merchandise type corresponding to the piece of the reference image information having the highest degree of similarity as the merchandise type of the object to be identified.

11. The merchandise item registration apparatus according to claim 10, wherein the identifying unit displays an image of the identified merchandise type on a display.

12. The merchandise item registration apparatus according to claim 11, wherein,
when the merchandise type of the object to be identified is to be identified based on the object recognition, and the degrees of similarity of the accumulated pieces of the reference image information are neither equal to nor higher than the first threshold value while the degrees of similarity of some of the pieces of the reference image information fall within a range of a second threshold value to the first threshold value, the some of the pieces of the reference image information being regarded as merchandise types,
the identifying unit displays images of the respective merchandise types as candidate merchandise types for the object to be identified on a display.

13. The merchandise item registration apparatus according to claim 12, wherein the identifying unit displays the candidate merchandise types in a line on the display.

14. The merchandise item registration apparatus according to claim 12, wherein,
when one of the candidate merchandise types displayed on the display is selected as the merchandise type of the object to be identified,
the identifying unit accumulates the image information about the object to be identified imaged by the camera as one of the pieces of the reference image information to be referred to at a time of merchandise type identification based on the object recognition, the image information being associated with the selected merchandise type.

15. A merchandise item registration apparatus comprising:
an item code acquiring unit configured to read a merchandise item code attached to a fruit;
an image information acquiring unit configured to acquire image information about the fruit by imaging the fruit at a time of sales registration; and
an identifying unit configured to identify a type of the fruit based on object recognition when the merchandise item code is not successfully read by the item code acquiring unit, the fruit having the image information acquired by the image information acquiring unit.

16. The merchandise item registration apparatus according to claim 15, wherein,
when the merchandise item code is successfully read by the item code acquiring unit,
the identifying unit identifies the type of the fruit based on the read merchandise item code, and accumulates the image information acquired by the image information acquiring unit as one of a plurality of pieces of reference image information to be referred to at a time of fruit type identification based on the object recognition, the image information being associated with the identified fruit type.

17. The merchandise item registration apparatus according to claim 16, wherein,
when the type of the fruit is to be identified based on the object recognition, and degrees of similarity of some of the pieces of the reference image information to the image information about the fruit acquired by the image information acquiring unit are equal to or higher than a first threshold value,
the identifying unit identifies a fruit type corresponding to the piece of the reference image information having the highest degree of similarity as the type of the fruit.

18. The merchandise item registration apparatus according to claim 17, wherein the identifying unit displays an image of the identified fruit type on a display.

19. The merchandise item registration apparatus according to claim 17, wherein,
when the type of the fruit is to be identified based on the object recognition, and the degrees of similarity of the accumulated pieces of the reference image information are neither equal to nor higher than the first threshold value while the degrees of similarity of some of the pieces of the reference image information fall within a range of a second threshold value to the first threshold value, the some of the pieces of the reference image information being regarded as fruit types,
the identifying unit displays images of the respective fruit types as candidate fruit types for the fruit on a display.

20. The merchandise item registration apparatus according to claim 19, wherein the identifying unit displays the candidate fruit types in a line on the display.
